(19) United States
(12) Patent Application Publication
(10) Pub. No.: US 2007/0046274 A1
(43) Pub. Date: Mar. 1, 2007

(54) Failure detecting device for a load driving system

(75) Inventor: Shougo Matsuoka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION

(21) Appl. No.: 11/501,759

(22) Filed: Aug. 10, 2006

(30) Foreign Application Priority Data
Aug. 23, 2005 (JP) P2005-241258

(51) Int. Cl. G05F 1/00; H02M 7/04

(52) U.S. Cl. 323/283; 363/89

(57) ABSTRACT

A failure detecting device for a load driving system including an upper arm driving means connected between a positive electrode of a direct current power source and one end of a load and a lower arm driving means connected between a negative electrode of the direct current power source and the other end of the load for on/off-controlling the respective driving means to control a voltage or an electric current to be supplied to the load, the failure detecting device including: resistor elements respectively connected in parallel to the upper arm driving means and the lower arm driving means; and a load condition anomaly detecting means for detecting an anomaly of the load driving system including the load or wiring to the load by observing terminal voltage of one or both of the load terminals.

### BACKGROUND OF THE INVENTION

1. Field of the Invention

The present invention relates to a failure detecting device for detecting anomalies of a load and condition of connection of the load in a load driving system.

2. Related Art

A conventional load driving system, an electric motor-drive device, for example, including a failure detecting means comprising: high resistors respectively connected in parallel to at least two FETs in which a source of one FET of a bridge circuit formed from four FETs (field effect transistors) as an electric motor driving means is connected to a drain of the other FET to form an arm, the high resistors having sufficiently larger resistance value than the resistance value of the case of an on failure of the FET; and a voltage detection means for detecting a voltage of the electric motor connected between output terminals of the bridge circuit. In the electric motor-drive device, providing the high resistors causes voltage values at the both terminals of the electric motor to be changed in an on failure of the FET, so that detection of a terminal voltage of the electric motor allows existence of an on failure of the FET to be judged. (Refer to Japanese Patent No. 3034508, for example.)

In another case, one end of each impedance element having the same number of phases as a multiphase alternating current motor and having the equal impedance value is connected to a reference neutral point while the other end of the impedance element is connected to each phase coil of the multiphase alternating current motor, the difference in potential between the reference neutral point of the impedance element and the neutral point to which the phase coil of the multiphase alternating current motor is connected is detected and anomalies of the phase coils are judged to exist when the potential difference exceeds a specified threshold voltage. (Refer to JP-A-6-311783, for example.)

Japanese Patent No. 3034508 is an example of related art.

JP-A-6-311783 is another example of related art.

In a system disclosed in Japanese Patent No. 3034508, however, it is arranged that resistor elements are connected to at least two FETs forming an arm, respectively, and a short-failure mode (a driving element short circuit, a terminal ground fault and a terminal power-source short circuit) in which a terminal voltage of a load (an electric motor) is a power source potential or a ground potential is able to be detected. This causes a problem that an open failure mode (disconnection) of a load or a load connecting line with no change in load terminal voltage cannot be detected.

On the other hand, in a system disclosed in JP-A-6-311783, the neutral point potential of the multiphase alternating current motor is compared with the reference neutral point potential formed by an impedance element to detect anomalies in accordance with the potential difference, so that the motor should be rotated to generate each phase voltage. Accordingly, the system cannot be applied to a case that it is judged whether current application causes a problem or not in an initial step for starting current application to a load from a stop state. This causes a problem that a large quantity of electric current is likely to flow when the load is in a failure condition such as a ground fault and a power-source short circuit.

### SUMMARY OF THE INVENTION

The invention is to solve the above problems. An object of the invention is to provide a failure detecting device for a load driving system capable of detecting anomalies (disconnection, a ground fault and a short circuit) of a load or a load connecting line, an on failure of a driving means formed from the above-mentioned FETs for carrying out feed or a break to the load and such before starting current application to the load.

A failure detecting device for a load driving system in accordance with the invention is a failure detecting device for a load driving system including an upper arm driving means connected between a positive electrode of a direct current power source and one end of a load and a lower arm driving means connected between a negative electrode of the direct current power source and the other end of the load for on/off-controlling the respective driving means to control a voltage or an electric current to be supplied to the load, the failure detecting device comprising: resistor elements respectively connected in parallel to the upper arm driving means and the lower arm driving means; and a load condition anomaly detecting means for detecting anomalies of the load driving system including the load or wiring to the load by observing terminal voltage of one or both of the load terminals.

In the failure detecting device for a load driving system in accordance with the invention, which is arranged as described above, a load and a load connecting line are used as one of means for determining potential generated at the respective terminals of the load while the driving means is all off. This allows a disconnection failure of the load or the load connecting line to be also clearly detected in addition to the power source short circuit and the ground failure in which the terminal potential of the load is forced to be fixed and the on failure of the driving element.

Further, enabling anomalies to be detected while the driving means is off makes feed to the load under a condition of the ground failure or the power source short circuit of the load or operation of the driving means under a condition of the on failure of the driving means unnecessary, so that safe and quick anomaly detection can be achieved.

Especially, in view of prevention and safety, sophistication of the anomaly detection of a connecting state of a load and the failure detection of the driving means at a low cost has been strongly required for a multiphase connecting load driving system represented by a rotary electric machine mounted to rolling stock or an automobile. The invention can provide a preferable anomaly detecting system.

### BRIEF DESCRIPTION OF THE DRAWINGS

The invention will be described with reference to the accompanying drawings, wherein like numbers reference like elements, and wherein:

FIG. 1 is a circuit diagram showing an example of a structure in accordance with Embodiment 1 of the invention;

FIG. 2 shows an example of the detected voltage in a normal condition and in anomalous conditions in Embodiment 1;

FIG. 3 is a circuit diagram showing an example of a structure in accordance with Embodiment 2 of the invention;

FIG. 4 shows an example of the detected voltage in a normal condition and in anomalous conditions in Embodiment 2;

FIG. 5 is a circuit diagram showing an example of a structure in accordance with Embodiment 3 of the invention;

FIG. 6 shows an example of the detected voltage in a normal condition and in anomalous conditions in Embodiment 3;

FIG. 7 is a circuit diagram showing another example of a structure in accordance with Embodiment 3 of the invention; and

FIG. 8 shows an example of the detected voltage in a normal condition and in anomalous conditions in the example shown in FIG. 7.

### DESCRIPTION OF THE PREFERRED EMBODIMENTS

### Embodiment 1

Now, Embodiment 1 of the invention will be described hereinafter on the basis of the drawings.

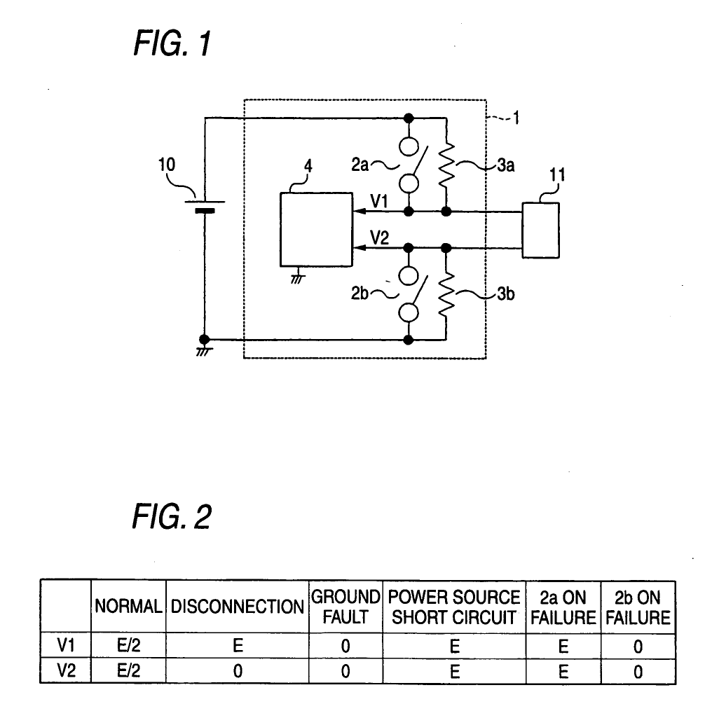

FIG. 1 is a circuit diagram showing an example of a structure in accordance with Embodiment 1. A load driving system 1 includes an upper arm driving means 2a formed from a semiconductor element such as an FET, for example, and a lower arm driving means 2b also formed from a semiconductor element such as an FET. One end of each driving means is connected to a direct current power source 10 such as a battery while the other end is connected to a load 11 such as an electric motor.

A resistor element 3a is connected in parallel to the upper arm driving means 2a. A resistor element 3b is connected in parallel to the lower arm driving means 2b. It is arranged that on/off control of the respective driving means 2a and 2b cause feed or a break to the load 11. Further, the other ends of the respective driving means 2a and 2b are connected with a later-mentioned load condition anomaly detection means 4.

In the load driving system shown in FIG. 1, load terminal voltages V1 (V) and V2 (V) can be respectively expressed by the following formulas (1) and (2) on the assumption that the wiring resistance is so small that it can be ignored:
V1=R11+(R2B//R3B)/R11+(R2A//R3A)+(R2B//R3B)·E (1)
V2=R2B//R3B/R11+(R2A//R3A)+(R2B//R3B)·E (2)
wherein
R2A//R3A=R2A·R3A/R2A+R3A
R2B//R3B=R2B·R3B/R2B+R3B
and wherein E (V) denotes a voltage of the direct current power source 10, R11 (Ω) denotes a direct current equivalent resistance value of the load 11, R2A (Ω) denotes an off time direct current equivalent resistance value of the upper arm element 2a, R2B (Ω) denotes an off time direct current equivalent resistance value of the lower arm element 2b, R3A (Ω) denotes a resistance value of a resistor element 3a and R3B (Ω) denotes a resistance value of a resistor element 3b.

R2A, R2B and R11 can be ignored when R3A and R3B are selected so as to satisfy R2A>>R3A, R2B>>R3B, R3A>>R11 and R3B>>R11 in the above formulas. Further, in order to make description easy, assumed is R3A=R3B in the above formulas.

In reviewing the formulas (1) and (2) on the basis of the assumptions, the load terminal voltages V1 (V) and V2 (V) are simplified as shown in the following formulas (1A) and (2A), respectively.
V1=R3B/R3A+R3B·E=E/2 (1A)
V2=R3B/R3A+R3B·E=E/2 (2A)

In the anomaly detection of the load driving system in accordance with Embodiment 1, it is basically arranged that a difference in change of the load terminal voltage between a normal condition and an anomalous condition is large as described later and this make discrimination easy while strictly fixing a numerical value is not made to be an absolute requirement. Accordingly, the description below will be simplified under the above-mentioned assumptions.

First, in the case that the load 11 or the load connecting line is disconnected, the load terminal voltage V1 (V) is almost equal to the power source voltage E (V) based on the assumptions of R2A>>R3A and R2B>>R3B. V2 (V) is almost equal to the ground voltage (assumed to be zero (V) in Embodiment 1) for the same reason as V1 (V).
V1≅E (1B)
V2≅0 (2B)

Next, in the case that the load 11 or the load connecting line is in a ground fault, particularly, in the case that the load 11 is normally connected while a part of the load or the load connecting line has a ground potential, the load terminal voltages V1 (V) and V2 (V) are almost equal to the ground voltage.
V1≅0 (1C)
V2≅0 (2C)

In the case that the load 11 or the load connecting line is power-source short-circuited, particularly, in the case that the load 11 is normally connected while a part of the load or the load connecting line has a power source potential E, the load terminal voltages V1 (V) and V2 (V) are almost equal to the power source voltage.
V1≅E (1D)
V2≅E (2D)

Further, when the load 11 is normally connected while the upper arm driving means 2a is in the on failure, the load terminal voltages V1 (V) and V2 (V) are almost equal to the power source voltage.
V1≅E (1E)
V2≅E (2E)

Moreover, when the load 11 is normally connected while the lower arm driving means 2b is in the on failure, the load terminal voltages V1 (V) and V2 (V) are almost equal to the ground voltage.
V1≅0 (1F)
V2≅0 (2F)

FIG. 2 is a list of results of the above formulas (1A) and (2A) to (1F) and (2F). As shown in FIG. 2, a difference in numeric value of V1 and V2 is distinctive between the normal condition and the anomalous conditions. A large difference in voltage between the normal condition and the anomalous conditions allows the possibility of error detection to be greatly reduced, so that the anomalous conditions can be definitely detected.

In addition, the anomaly can be also detected similarly to the above in a load side ground fault, a terminal side ground fault, a load side power source short circuit, a terminal side power source short circuit, an on failure of the upper arm element or the lower arm element or a combination thereof under a condition that the load connecting line is disconnected. The concrete description will be omitted since the above exemplification can easily lead the respective cases to the result.

Furthermore, only observing any one of the voltages V1 and V2 in all the above-mentioned cases allows anomalies to be detected.

### Embodiment 2

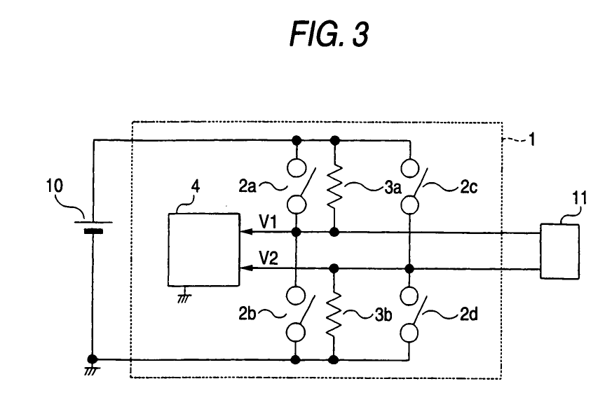

Now, Embodiment 2 of the invention will be described on the basis of the drawings. FIG. 3 is a circuit diagram showing an example of a structure in accordance with Embodiment 2. In the load driving system 1 in Embodiment 2, a first driving means including the upper arm element 2a, which is formed from a semiconductor element such as an FET, and the lower arm element 2b, which is also formed from a semiconductor element such as an FET and connected in series with the upper arm element 2a, and a second driving means including the upper arm element 2c, which is formed from a semiconductor element such as an FET, and the lower arm element 2d, which is also formed from a semiconductor element such as an FET and connected in series with the upper arm element 2c, are connected to the direct current power source 10 such as a battery while the load 11 and the load condition anomaly detecting means 4 are connected between a connecting point of the upper arm element 2a and the lower arm element 2b of the first driving means and a connecting point of the upper arm element 2c and the lower arm element 2d of the second driving means.

A resistor element 3a is connected in parallel to the upper arm element 2a of the first driving means while a resistor element 3b is connected in parallel to the lower arm element 2d of the second driving means. It is arranged that on/off control of the upper arm element and the lower arm element of the first and second driving means allow feed or a break to the load 11 to be performed.

In the load driving system in FIG. 3, it is assumed that the voltage of the direct current power source 10 is E (V), the direct current equivalent resistance value of the load 11 is R11 (Ω), the off time direct current equivalent resistance values of the respective arm elements 2a to 2d of the first and second driving means are R2A (Ω) to R2D (Ω), the resistance value of the resistor element 3a is R3A (Ω) and the resistance value of the resistor element 3b is R3B (Ω), for example. Further, the wiring resistance is assumed to be small enough that it can be ignored.

The load terminal voltages V1 (V) and V2 (V) can be expressed by the following formulas (3A) and (4A), respectively, under assumptions similar to Embodiment 1.
V1=R3B/R3A+R3B·E=E/2 (3A)
V2=R3B/R3A+R3B·E=E/2 (4A)

First, in the case that the load 11 or the load connecting line is disconnected, V1 (V) is almost equal to the power source voltage E (V) while V2 (V) is almost equal to the ground voltage (assumed to be zero (V) in Embodiment 2).
V1≅E (3B)
V2≅0 (4B)

Next, in the case that the load 11 or the load connecting line is in a ground fault, particularly, in the case that the load 11 is normally connected while a part of the load or the load connecting line has a ground potential, the load terminal voltages V1 (V) and V2 (V) are almost equal to the ground voltage.
V1≅0 (3C)
V2≅0 (4C)

In the case that the load 11 or the load connecting line is power-source short-circuited, particularly, in the case that the load 11 is normally connected while a part of the load or the load connecting line has a power source potential E, the load terminal voltages V1 (V) and V2 (V) are almost equal to the power source voltage.
V1≅E (3D)
V2≅E (4D)

Further, when the load 11 is normally connected while one or both of the upper arm element 2a of the first driving means and the upper arm element 2c of the second driving means is in the on failure, the load terminal voltages V1 (V) and V2 (V) are almost equal to the power source voltage.
V1≅E (3E)
V2≅E (4E)

Moreover, when the load 11 is normally connected while one or both of the lower arm element 2b of the first driving means and the lower arm element 2d of the second driving means is in the on failure, the load terminal voltages V1 (V) and V2 (V) are almost equal to the ground voltage.
V1≅0 (3F)
V2≅0 (4F)

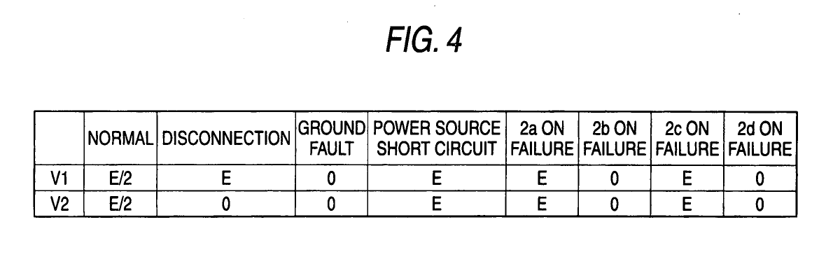

FIG. 4 is a list of results of the above formulas (3A) and (4A) to (3F) and (4F). As shown in FIG. 4, a difference in numeric value of V1 and V2 is distinctive between the normal condition and the anomalous condition even in a load driving system in which a semiconductor element such as an FET is H-bridge-connected and a large difference in voltage between the normal condition and the anomalous condition allows the possibility of error detection to be greatly reduced, so that the anomalous condition can be definitely detected.

In addition, the anomaly can be also detected similarly to the above in a load side ground fault, a terminal side ground fault, a load side power source short circuit, a terminal side power source short circuit, an on failure of the respective upper arm elements of the first and second driving means or a combination thereof under a condition that the load connecting line is disconnected. The concrete description will be omitted since the above exemplification can easily lead the respective cases to the result.

Furthermore, only observing any one of the voltages V1 and V2 in all the above-mentioned cases allows anomalies to be detected.

### Embodiment 3

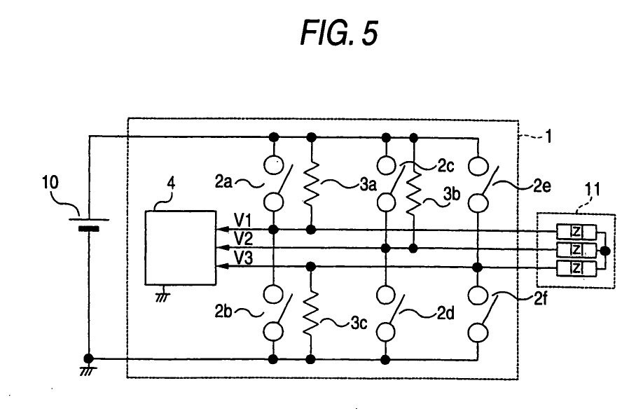

Now, Embodiment 3 of the invention will be described on the basis of the drawings. FIG. 5 is a circuit diagram showing an example of a structure in accordance with Embodiment 3. In the load driving system 1 in Embodiment 3, a first driving means including the upper arm element 2a, which is formed from a semiconductor element such as an FET, and the lower arm element 2b, which is also formed from a semiconductor element such as an FET and connected in series with the upper arm element 2a, a second driving means including the upper arm element 2c and the lower arm element 2d connected to the upper arm element 2c in series, the second driving means being formed similarly to the first driving means, and a third driving means including the upper arm element 2e and the lower arm element 2f connected to the upper arm element 2e in series, the third driving means being formed similarly to the first driving means, are respectively connected in parallel to the direct current power source 10 such as a battery while the respective phase terminals of the multiphase connecting load 11 and the load condition anomaly detecting means 4 are connected to connecting points of the upper arm elements and the lower arm elements of the respective driving means.

An upper resistor element is connected in parallel to the upper arm elements of the plural driving means, the driving means being not one or all in number among the driving means, while a lower resistor element is connected in parallel to the lower arm element of the driving means to which no upper resistor element is connected. In the case shown in FIG. 5, an upper resistor elements 3a and 3b are respectively connected in parallel to the upper arm elements 2a and 2c of the first and second driving means while a lower resistor element 3c is connected in parallel to the lower arm element 2f of the third driving means. It is arranged that on/off control of the upper and lower arm elements 2a to 2f of the respective driving means allow feed or a break to the multiphase connecting load 11 to be performed.

The multiphase connecting load 11 in the load driving system in FIG. 5 is assumed to be a Y connecting line or a delta connecting line, which are represented by a three-phase current rotary machine. That is to say, it means that the respective phase terminals of the load 11 are connected at low impedance including zero Ω (short circuit). Accordingly, the multiphase connecting load 11 is not limited to the specific equipment or a connecting method.

In the load driving system in FIG. 5, it is also assumed that the voltage of the direct current power source 10 is E (V), the direct current equivalent resistance value of the multiphase connecting load 11 is R11 (Ω), the off time direct current equivalent resistance values of the respective arm elements 2a to 2f of the first to third driving means are R2A (Ω) to R2F (Ω), the resistance value of the resistor element 3a is R3A (Ω), the resistance value of the resistor element 3b is R3B (Ω) and the resistance value of the resistor element 3C is R3C (Ω), for example. The wiring resistance is assumed to be small enough that it can be ignored.

The load terminal voltages V1 (V), V2 (V) and V3 (V) can be expressed by the following formulas (5A), (6A) and (7A), respectively, under assumptions similar to Embodiment 1.
V1=R3C/(R3A//R3B)+R3C·E=E/2 (5A)
V2=R3C/(R3A//R3B)+R3C·E=E/2 (6A)
V3=R3C/(R3A//R3B)+R3C·E=E/2 (7A)
wherein
R3A//R3B=R3A·R3B/R3A+R3B.

In Embodiment 3, a condition of R3A=2×R3C and R3B=2×R3C is added to the above-mentioned assumption for the purpose of easy description.

First, in the case of disconnection of the multiphase connecting load 11 or the load connecting line in which a part of a line connected to the resistor element 3a is disconnected while lines connected to the resistor elements 3b and 3c are normally connected, V1 (V) is almost equal to the power source voltage E (V) and V2 (V) and V3 (V) are divided almost at a ratio of R3B and R3C.
V1=E (5B)
V2=R3C/R3B+R3C·E=E/3 (6B)
V3=R3C/R3B+R3C·E=E/3 (7B)

Second, in the case of disconnection of the multiphase connecting load 11 or the load connecting line in which a part of a line connected to the resistor element 3b is disconnected while lines connected to the resistor elements 3a and 3c are normally connected, V2 (V) is almost equal to the power source voltage E (V) and V1 (V) and V3 (V) are divided almost at a ratio of R3A and R3C.
V1=R3C/R3B+R3C·E=E/3 (5C)
V2=E (6C)
V3=R3C/R3B+R3C·E=E/3 (7C)

Third, in the case of disconnection of the multiphase connecting load 11 or the load connecting line in which a part of a line connected to the resistor element 3c is disconnected while lines connected to the resistor elements 3a and 3b are normally connected, V3 (V) is almost equal to the ground voltage (assumed to be zero (V) in Embodiment 3) and V1 (V) and V2 (V) are almost equal to the power source voltage E (V).
V1≅E (5D)
V2≅E (6D)
V3≅0 (7D)

Further, in the case that the multiphase connecting load 11 or the load connecting line is in a ground fault, particularly, in the case that the multiphase connecting load 11 is normally connected while a part of the multiphase connecting load or the load connecting line has a ground potential, the load terminal voltages V1 (V), V2 (V) and V3 (V) are almost equal to the ground voltage.
V1≅0 (5E)
V2≅0 (6E)
V3≅0 (7E)

Moreover, in the case that the multiphase connecting load 11 or the load connecting line is power-source short-circuited, particularly, in the case that the multiphase connecting load 11 is normally connected while a part of the multiphase connecting load or the load connecting line has a power source potential, the load terminal voltages V1 (V), V2 (V) and V3 (V) are almost equal to the power source voltage.
V1≅E (5F)
V2≅E (6F)
V3≅E (7F)

In addition, when the multiphase connecting load 11 is normally connected while one or a plurality of the upper arm elements 2a, 2c and 2e of the first, second and third driving means is in the on failure, the load terminal voltages V1 (V), V2 (V) and V3 (V) are almost equal to the power source voltage.
V1≅E (5G)
V2≅E (6G)
V3≅E (7G)

Furthermore, when the multiphase connecting load 11 is normally connected while one or a plurality of the lower arm elements 2b, 2d and 2f of the first, second and third driving means is in on-failure, the load terminal voltages V1 (V), V2 (V) and V3 (V) are almost the ground voltage.
V1≅0 (5H)
V2≅0 (6H)
V3≅0 (7H)

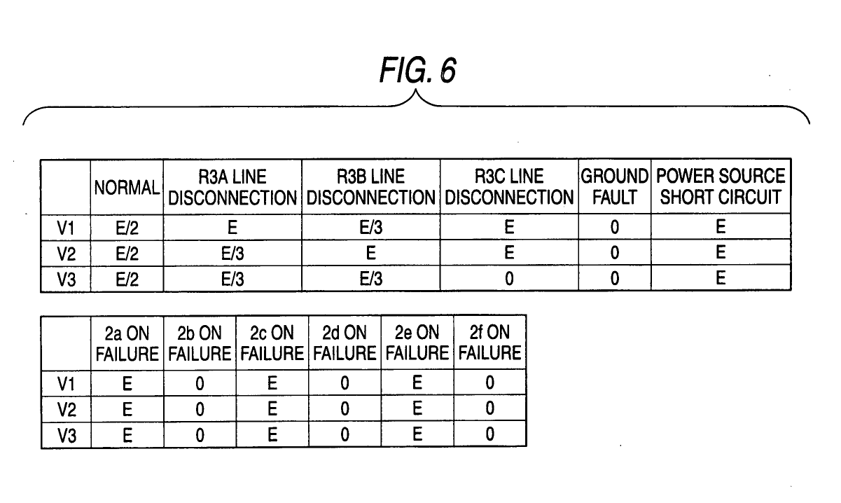

FIG. 6 is a list of results of the above formulas (5A), (6A) and (7A) to (5H), (6H) and (7H). As shown in FIG. 6, in a load driving system in which a semiconductor element such as an FET is three-phase-bridge-connected, a difference is also distinctive between the normal condition and the anomalous condition and can be definitely detected.

In addition, the anomaly can be also detected similarly to the above in a load side ground fault, a terminal side ground fault, a load side power source short circuit, a terminal side power source short circuit, an on failure of the arm element of the driving means or a combination thereof under a condition that the load connecting line is disconnected. The concrete description will be omitted since the above exemplification can easily lead the respective cases to the result.

Furthermore, only observing any one of the voltages V1 to V3 in all the above-mentioned cases allows anomalies to be detected.

By the way, in the above-mentioned respective embodiments, there is sometimes a case of providing one or plural shunt resistors on the electric connecting wiring for the purpose of measuring a value of the current flowing to the load to form a series circuit including the shunt resistor in a view of the load driving system from a side of both of the positive and negative electrodes of the power source. In all embodiments, when the load terminal voltage V1 (V) or V2 (V) is measured with the negative electrode potential (the ground potential) of the direct current power source used as a reference, a shunt resistance value is considered to be likely to influence a ratio of the divided voltages so long as the resistor element connected in parallel to the upper arm element and the resistor element connected in parallel to the lower arm element form a series circuit together with the shunt resistor.

The direct current equivalent resistance value of the arm element, however, is tens of MΩ or more in the case of a typical switching element such as a MOSFET, for example, while the direct current equivalent resistance value of the load 11 is a few Ω or less. Resistance values of the resistor elements 3a to 3c, which are expected to be selected, are supposed to be tens of kΩ to hundreds of kΩ. Accordingly, it is not a matter at all to ignore the shunt resistance value when the shunt resistance is of a general value (a few Ω or less), so that the above-mentioned results are constant.

In Embodiment 2, the lower arm element 2b of the first driving means should be connected to the resistor element 3b in parallel when the upper arm element 2c of the second driving means is connected to the resistor element 3a in parallel. It is possible to detect anomalies even in this case, similarly to the above-mentioned case of Embodiment 2. The concrete description will be omitted here since the above exemplification can easily lead the respective cases to the result.

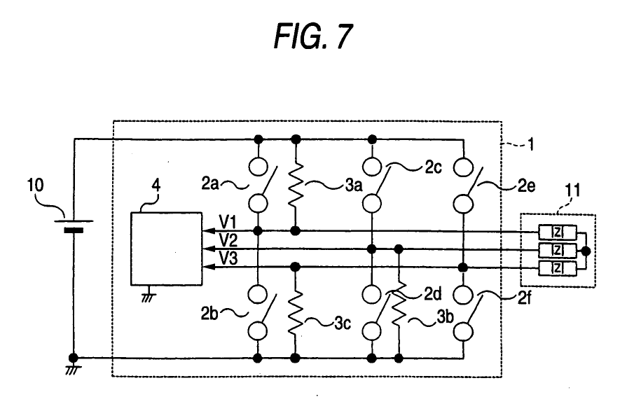

In Embodiment 3, it may be possible as shown in FIG. 7 to connect the resistor element 3a in parallel to the upper arm element 2a of the first driving means and connect the resistor elements 3b and 3c in parallel to the lower arm elements 2d and 2f of the second and third driving means, respectively. In this case, the condition is changed into R3B=2×R3A and R3C=2×R3A to obtain a normal load terminal voltage as follows:
V1=(R3B//R3C)/R3A+(R3B//R3C)·E=E/2 (8A)
V2=(R3B//R3C)/R3A+(R3B//R3C)·E=E/2 (9A)
V3=(R3B//R3C)/R3A+(R3B//R3C)·E=E/2 (10A)
wherein R3B//R3C=R3B·R3C/R3B+R3C.

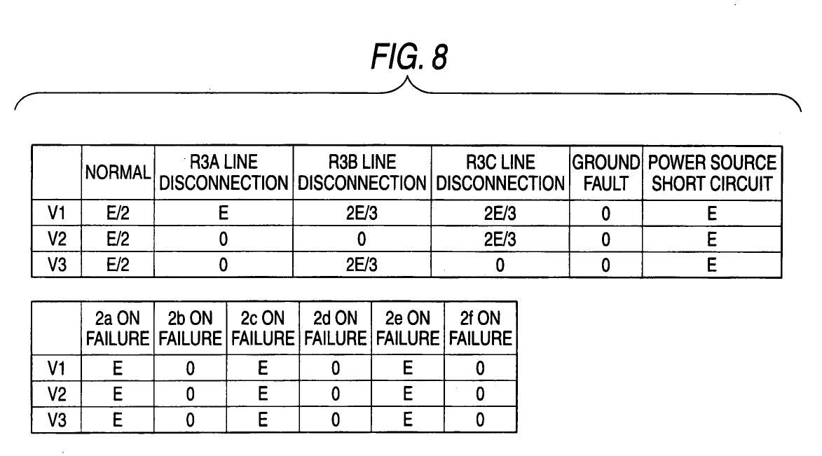

Description of the voltage generated in an anomalous case is omitted but the voltage is obtained as shown in FIG. 8 by an operation similar to the above description. Accordingly, anomalies can be easily detected.

What is claimed is:

1. A failure detecting device for a load driving system including an upper arm driving means connected between a positive electrode of a direct current power source and one end of a load and a lower arm driving means connected between a negative electrode of the direct current power source and the other end of the load for on/off-controlling the respective driving means to control a voltage or an electric current to be supplied to the load, the failure detecting device comprising:
resistor elements respectively connected in parallel to the upper arm driving means and the lower arm driving means; and
a load condition anomaly detecting means for detecting an anomaly of the load driving system including the load or wiring to the load by observing terminal voltage of one or both of the load terminals.

2. The failure detecting device for a load driving system according to claim 1, wherein resistance values of the resistor elements connected in parallel to the upper arm element and the lower arm element of the driving means are sufficiently smaller than the direct current equivalent resistance value in an off state of the driving means and sufficiently larger than the value of the direct current equivalent resistance between the terminals of the load.

3. The failure detecting device for a load driving system according to claim 2, wherein the terminal voltage of the load in the state that all of the driving means are off is used to judge existence of a failure.

4. A failure detecting device for a load driving system including a first driving means having an upper arm element and a lower arm element, which are formed from a semiconductor element and which are connected to each other in series, a second driving means having an upper arm element and a lower arm element, which are formed from a semiconductor element and which are connected to each other in series, the first and second driving means being connected to a direct current power source in parallel, and a load connected between a connecting point of the upper arm element and the lower arm element of the first driving means and a connecting point of the upper arm element and the lower arm element of the second driving means for on/off-controlling the respective semiconductor elements to control a voltage or an electric current to be supplied to the load, the failure detecting device comprising:
resistor elements respectively connected in parallel to the upper arm element of the first driving means and the lower arm element of the second driving means; and
a load condition anomaly detecting means for detecting an anomaly of the load driving system including the load or wiring to the load by observing terminal voltage of one or both of the load terminals.

5. The failure detecting device for a load driving system according to claim 4, wherein resistance values of the resistor elements connected in parallel to the upper arm element and the lower arm element of the driving means are sufficiently smaller than the direct current equivalent resistance value in an off state of the driving means and sufficiently larger than the value of the direct current equivalent resistance between the terminals of the load.

6. The failure detecting device for a load driving system according to claim 5, wherein the terminal voltage of the load in the state that all of the driving means are off is used to judge existence of a failure.

7. A failure detecting device for a load driving system including three or more driving means having an upper arm element and a lower arm element, which are formed from a semiconductor element and which are connected to each other in series, the three or more driving means being respectively connected to a direct current power source in parallel, and each phase terminal of a multiphase connecting load is connected to a connecting point of the upper arm element and the lower arm element of each driving means for on/off-controlling the respective semiconductor elements to control a voltage or an electric current to be supplied to the multiphase connecting load, the failure detecting device comprising:
an upper resistor element connected in parallel to the upper arm element of the plural driving means, the driving means being not one or all in number among the driving means;
a lower resistor element connected in parallel to the lower arm element of the driving means to which the upper resistor element is not connected; and
a load condition anomaly detecting means for detecting an anomaly of the load driving system including the multiphase connecting load or wiring to the multiphase connecting load by observing terminal voltage in any one or a plurality of the phases of the multiphase connecting load.

8. The failure detecting device for a load driving system according to claim 7, wherein resistance values of the resistor elements connected in parallel to the upper arm element and the lower arm element of the driving means are sufficiently smaller than the direct current equivalent resistance value in an off state of the driving means and sufficiently larger than the value of the direct current equivalent resistance between the terminals of the multiphase connecting load.

9. The failure detecting device for a load driving system according to claim 8, wherein the terminal voltage of the multiphase connecting load in the state that all of the driving means are off is used to judge existence of a failure.
